(19) United States
(12) Patent Application Publication
(10) Pub. No.: US 2025/0372014 A1
(43) Pub. Date: Dec. 4, 2025

(54) Methods and Electronic Devices for Moving Content Presented on a Display as a Function of Device Geometry and Support Condition

(71) Applicant: Motorola Mobility LLC, Chicago, IL (US)

(72) Inventors: Amit Kumar Agrawal, Bangalore (IN); Daniel M Vacura, Chicago, IL (US); Bill Ryan, Libertyville, IL (US)

(21) Appl. No.: 18/676,303

(22) Filed: May 28, 2024

(51) Int. Cl. G09G 3/00; G06F 1/16; G06F 3/01; G06F 3/0346; H04M 1/02; H04N 23/63

(52) U.S. Cl. CPC G09G 3/035; G06F 1/163; G06F 1/1652; G06F 3/013; G06F 3/017; G06F 3/0346; H04M 1/0268; H04M 1/0279; H04N 23/632; G09G 2340/0464; G09G 2354/00; H04M 2250/52

(57) ABSTRACT

A method in an electronic device includes detecting, with one or more sensors, a wrapped geometric form factor defined by a flexible display supported by a deformable housing and presenting, with one or more processors, content on the flexible display in a first location. The method also detects, with one or more other sensors, gesture input translating the electronic device in three-dimensional space while the wrapped geometric form factor is occurring and moving, by the one or more processors, the content on the flexible display in response to the translating to a second location as a function of a change in orientation of the electronic device in three-dimensional space resulting from the translating.

### BACKGROUND

### Technical Field

This disclosure relates generally to electronic devices, and more particularly to deformable electronic devices.

### Background Art

Portable electronic communication devices, especially smartphones, have become ubiquitous. People all over the world use such devices to stay connected. These devices have been designed in various mechanical configurations. A first configuration, known as a “candy bar,” is generally rectangular in geometric configuration, has a rigid form factor, and has a display disposed along a major face of the electronic device. By contrast, a “clamshell” device has a mechanical hinge that allows one housing to pivot relative to the other.

Some consumers prefer fixed geometric configuration devices such as candy bar devices. However, many others prefer deformable electronic devices such as clamshell devices. It would be advantageous to have an improved electronic device can operate in both deformed and non-deformed states.

### BRIEF DESCRIPTION OF THE DRA WINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

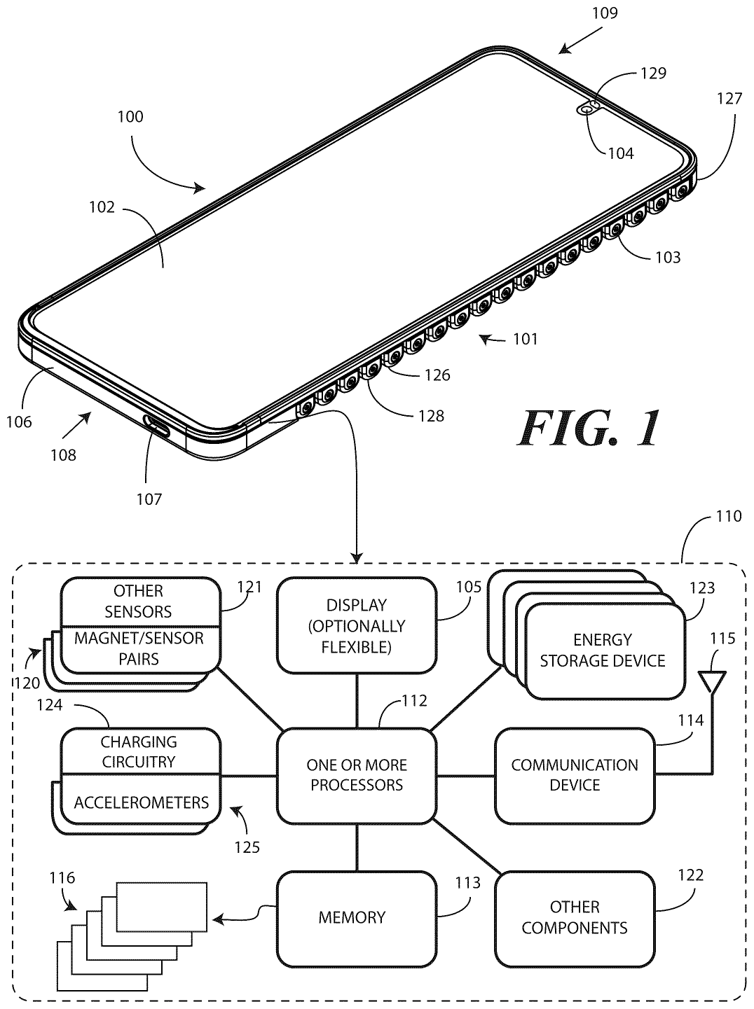

FIG. 1 illustrates one explanatory deformable electronic device in accordance with one or more embodiments of the disclosure.

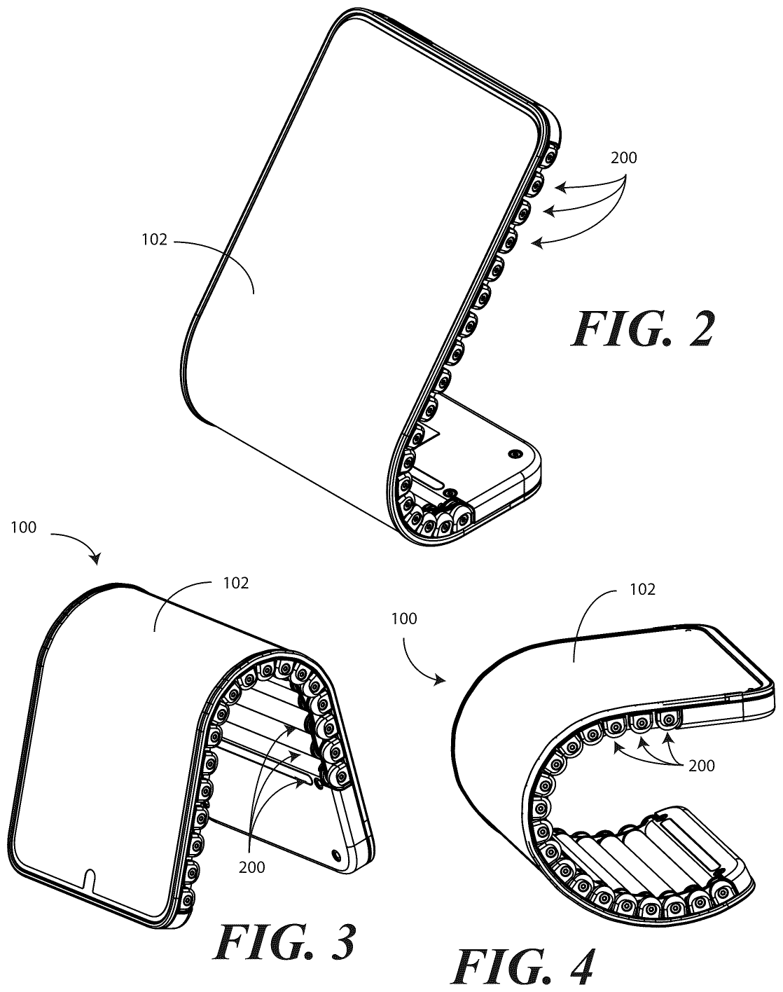

FIG. 2 illustrates one explanatory deformable electronic device in accordance with one or more embodiments of the disclosure when in a deformed to a “L stand” geometric configuration.

FIG. 3 illustrates one explanatory deformable electronic device in accordance with one or more embodiments of the disclosure when in a deformed to a “tent pad” geometric configuration.

FIG. 4 illustrates one explanatory deformable electronic device in accordance with one or more embodiments of the disclosure when in a deformed to a “wrap” geometric configuration.

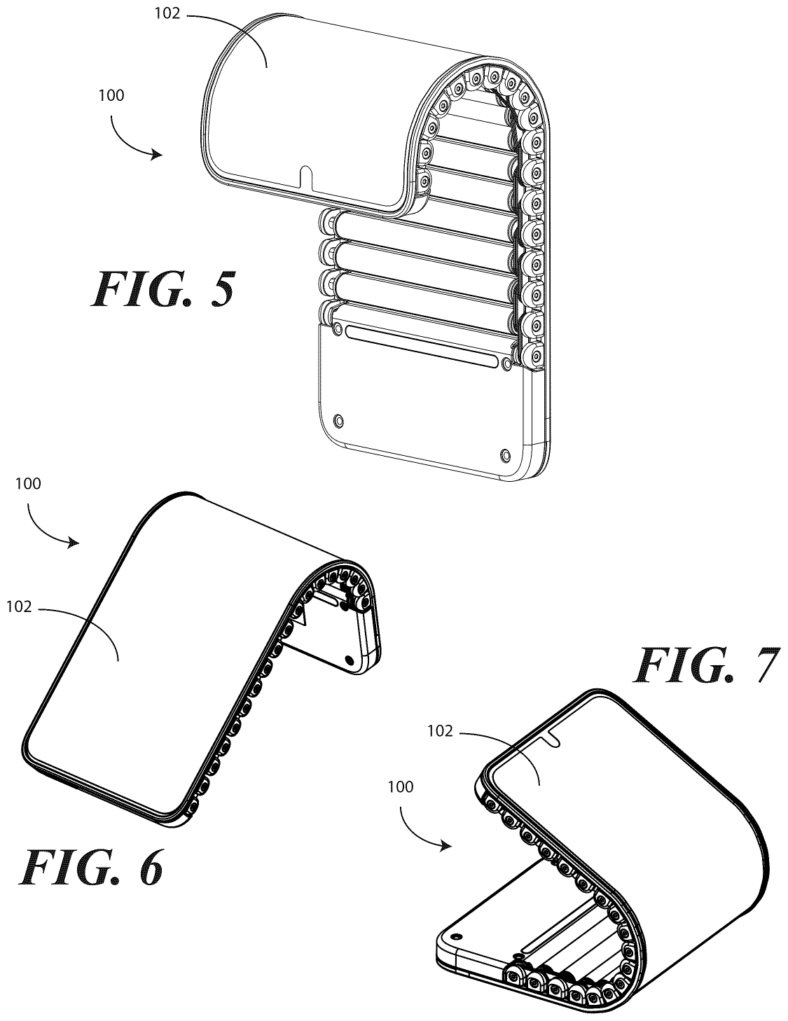

FIG. 5 illustrates one explanatory deformable electronic device in accordance with one or more embodiments of the disclosure when in a deformed to a “hook” geometric configuration.

FIG. 6 illustrates one explanatory deformable electronic device in accordance with one or more embodiments of the disclosure when in a deformed to a “L pad” geometric configuration.

FIG. 7 illustrates one explanatory deformable electronic device in accordance with one or more embodiments of the disclosure when in a deformed to a “tent lean back” geometric configuration.

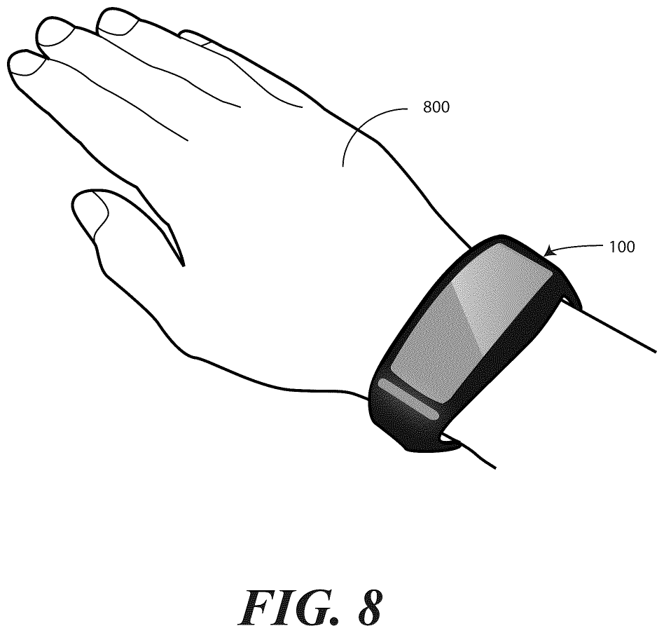

FIG. 8 illustrates one explanatory electronic device in accordance with one or more embodiments of the disclosure in a wrapped geometric form factor while being worn on the wrist of a user.

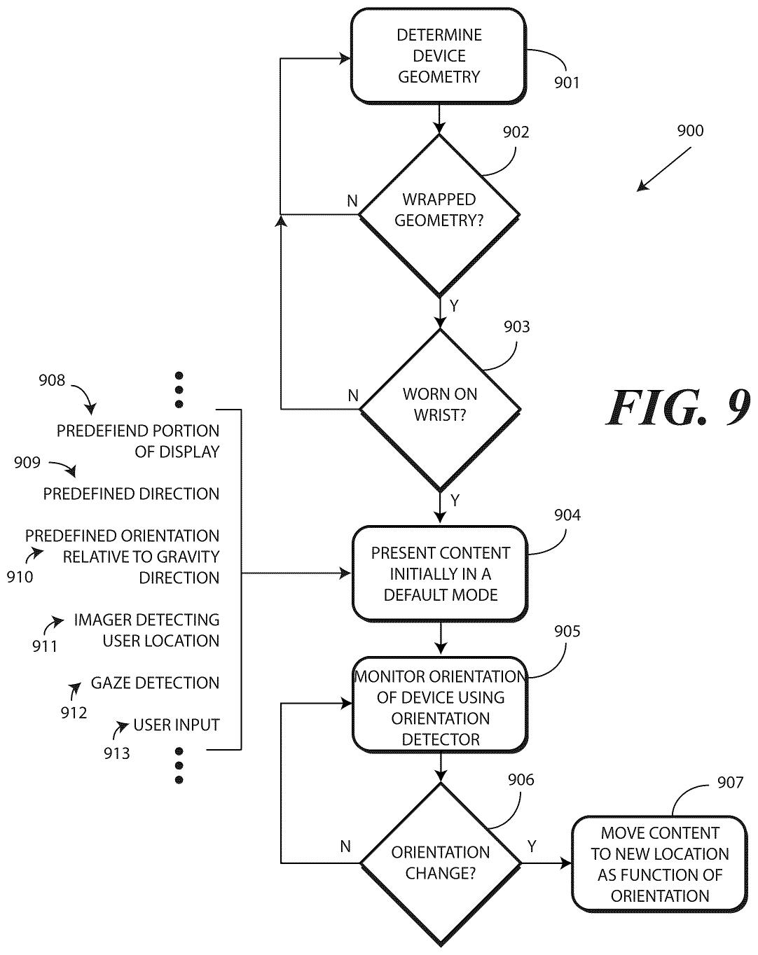

FIG. 9 illustrates one explanatory method in accordance with one or more embodiments of the disclosure.

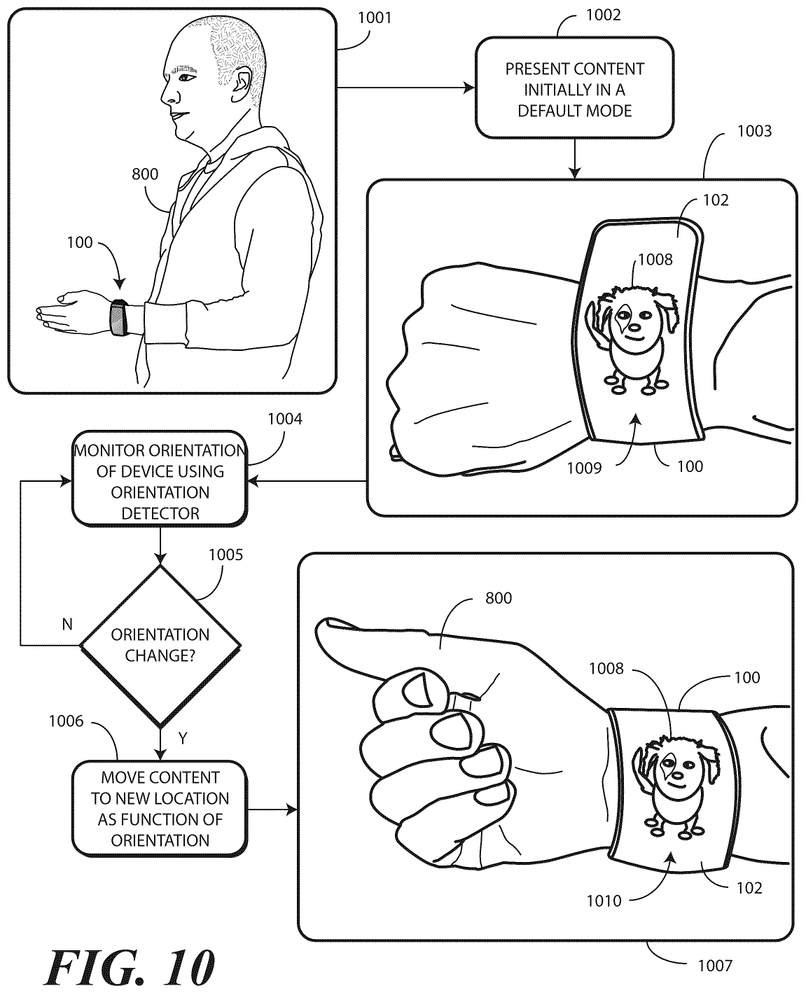

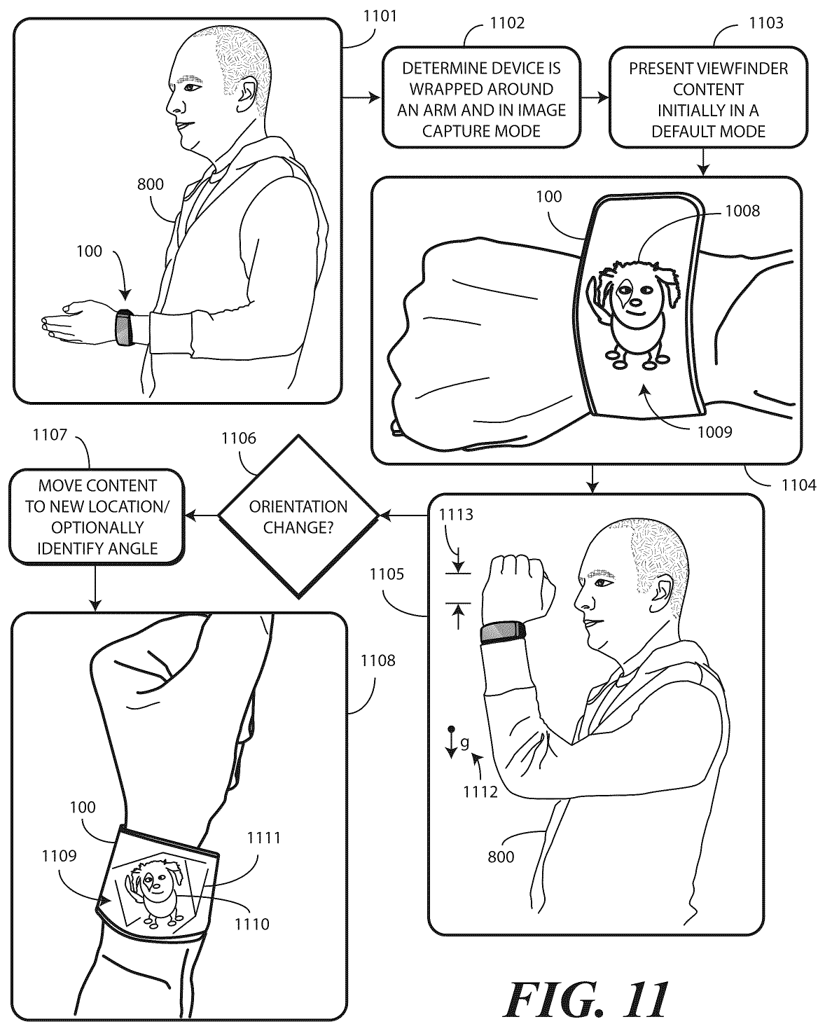

FIG. 10 illustrates another explanatory method in accordance with one or more embodiments of the disclosure.

FIG. 11 illustrates still another explanatory method in accordance with one or more embodiments of the disclosure.

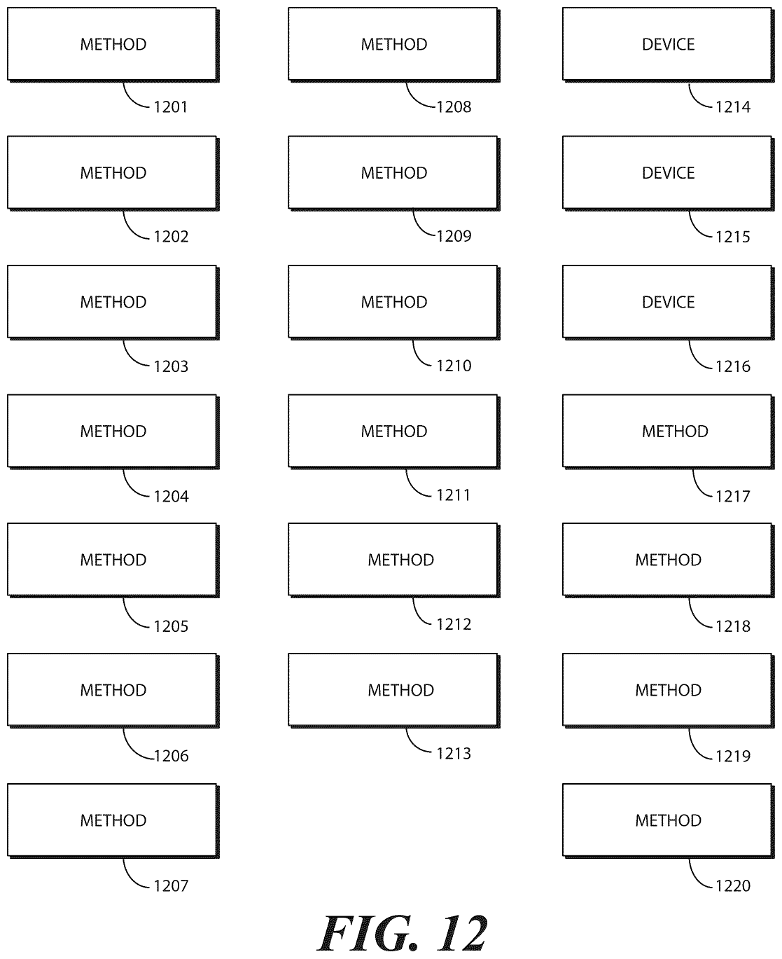

FIG. 12 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to moving, by one or more processors, content being presented on a flexible display in response to gesture input translating the electronic device in three-dimensional space while the electronic device is in a wrapped geometric form factor from a first location to a second location as a function of a change in orientation of the electronic device in the three-dimensional space. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of causing a content presentation on the flexible display to move along the flexible display as a function of changes in the orientation of the electronic device in three-dimensional space while the electronic device is in a wrist-worn, wrapped geometric form factor. As such, these functions may be interpreted as steps of a method to cause, with one or more processors in response to at least a first sensor detecting a wrapped geometry about a wrist and at least a second sensor detecting a rotational and/or lifting operation of the electronic device in three-dimensional space, content presented on the flexible display supported by the deformable device housing to move in proportion to the rotational and/or lifting operation.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially”, “essentially”, “approximately”, “about” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Electronic devices with flexible displays have introduced new possibilities for user interaction and functionality. These devices can transform into various form factors, such as flat, tent, or wrist-worn configurations, adapting to different use cases. However, the unique form factor of an adaptive wearable display device, particularly when worn on the wrist, poses challenges for optimal viewing. The fixed display portion may not always be ideally positioned for viewing, especially when the device is rotated or moved at an angle. This can result in certain areas of the screen being occluded and not visible to the user. Therefore, there is a need to manage the viewing window on the adaptive wearable display device to automatically adjust itself based on the device movement in the user's wrist, ensuring that the content can be viewed without having to move the device.

Advantageously, embodiments of the disclosure propose a solution to the problem of managing the viewing window on an adaptive wearable display device. The solution involves detecting the form factor of the device, particularly when it is in a wrapped geometry around the wrist. In a default mode, where the user does not intend to move the device while moving their forearm or wrist, the solution utilizes inertial measurement units (IMU) and flex sensors to detect the angle of the device, which determines the probable viewing area of the screen.

Based on the changes in the probable viewing area, the content on the flexible display is automatically moved up, down, or at an angle to ensure it is in a viewable location. This adjustment is done by the software, which optimizes the location of the presentation area to enable the user to view the display content without having to move the device while their forearm moves.

In an alternate embodiment, the probable viewing area can be the camera preview area, which adjusts according to the movement of the camera preview angle. The device can show the field of view (FOV) of the camera by drawing lines coming out of the sensor to indicate what the sensor is aiming at.

Overall, the solution advantageously provides a flexible viewing area on the adaptive wearable display device, allowing the content to adjust itself based on the device movement. This ensures that the user can easily consume the displayed content without any hindrance, making the device more user-friendly and convenient to use.

In one or more embodiments, a method in an electronic device comprises detecting, with one or more sensors, a wrapped geometric form factor defined by a flexible display supported by a deformable housing. In one or more embodiments the method comprises presenting, with one or more processors, content on the flexible display in a first location.

In one or more embodiments, the method also comprises detecting, with one or more other sensors, gesture input translating the electronic device in three-dimensional space while the wrapped geometric form factor is occurring. In one or more embodiments, the method comprises moving, by the one or more processors, the content on the flexible display in response to the translating to a second location as a function of a change in orientation of the electronic device in three-dimensional space resulting from the translating.

Advantageously, embodiments of the disclosure automatically move the viewing window within different display portions based on the device's movement to align with an optimal area for the user's view. This concept is particularly relevant when the device is in a wrapped geometry around the wrist. By utilizing sensors such as inertial measurement units and flex sensors, the system can detect the angle of the device and determine the probable viewing area of the screen. This allows the content to be automatically adjusted to a viewable location, optimizing the user's viewing experience. Additionally, embodiments of the disclosure introduce the possibility of using the camera preview area as the probable viewing area, with the electronic device showing the field of view of the camera through visual indicators. These novel features enhance the usability and convenience of the adaptive wearable display device, setting it apart from existing solutions in the market.

In one or more embodiments, an electronic device comprises a deformable housing having a plurality of linkage members and a flexible display supported by the deformable housing. In one or more embodiments, the electronic device comprises one or more sensors operable to determine a wrapped, wrist-worn geometric configuration of the electronic device and one or more other sensors operable to detect when the electronic device changes orientation in three-dimensional space.

In one or more embodiments, the electronic device comprises one or more processors operable with the one or more sensors and the one or more other sensors. In one or more embodiments, the one or more processors are operable to cause a content presentation on the flexible display to move along the flexible display as a function of the changes in the orientation of the electronic device in the three-dimensional space while the electronic device is in the wrapped, wrist-worn geometric configuration.

Embodiments of the disclosure contemplate that wearable electronic device with flexible displays present challenges in user interaction and content visibility. When such devices are worn on the wrist, the orientation of the display relative to the user's eyes can vary significantly due to natural movements of the arm and wrist. Traditional fixed displays on wearable devices may not align with the user's line of sight, leading to difficulties in viewing content. For instance, when a user rotates their wrist or moves their forearm, parts of the display may become occluded or difficult to see, which can hinder the user experience.

Existing solutions for enhancing content visibility on wearable devices with flexible displays often require manual adjustment by the user. This can be cumbersome and interrupt the flow of interaction, especially when the user is engaged in activities that limit their ability to use their hands for device adjustment. Furthermore, these solutions may not dynamically adapt to the continuous changes in the device's orientation relative to the user's field of view, resulting in a less than optimal viewing experience.

The disclosed technology addresses these challenges by providing a method and system for managing the viewing window on an adaptive wearable display device. The system dynamically adjusts the content presentation on the display in response to changes in the device's orientation, ensuring that the content remains within the user's probable viewing area. This dynamic adjustment is achieved through the use of sensors that detect the device's angle and orientation, allowing the content to move automatically and maintain visibility without requiring manual intervention by the user. The technology enhances the user experience by providing a seamless and intuitive way to interact with content on wearable devices with flexible displays.

Indeed, in one or more embodiments a method in an electronic device comprises detecting, with at least a first sensor, a deformable device housing of the electronic device being transitioned to a wrapped geometry about a wrist. In one or more embodiments, the method comprises detecting, with at least a second sensor, a rotational and/or lifting operation of the electronic device in three-dimensional space.

In one or more embodiments, in response to the at least a first sensor detecting the wrapped geometry about the wrist and the at least a second sensor detecting the rotational and/or lifting operation, the method comprises causing, with one or more processors, content presented on a flexible display supported by the deformable device housing to move in proportion to the rotational and/or lifting operation. In one or more embodiments, an outward facing vector extending distally from the content remains oriented in a constant direction during the rotational and/or lifting operation.

Advantageously, by detecting the wrapped geometric form factor of the electronic device with sensors and presenting content on a flexible display, embodiments of the disclosure allow for dynamic adjustment of the content's location in response to the device's orientation changes in three-dimensional space. This ensures that the content remains in an optimal viewing position for the user, enhancing the usability and ergonomics of the device when worn on the wrist.

The integration of gesture input detection with the movement of content across the flexible display provides an intuitive interaction mechanism. As the user translates the device in space, the content seamlessly transitions to a new location on the display, which is determined by the change in orientation. This interaction reduces the need for manual adjustments and maintains the visibility of important information, improving the overall user experience.

Other embodiments and variations on the described embodiments will be obvious to those of ordinary skill in the art having the benefit of this disclosure. Illustrating by example, in one embodiment of the adaptive wearable display device, the deformable housing is constructed from a series of interconnected, flexible linkage members that allow the device to conform to the user's wrist, creating a seamless and comfortable fit. The flexible display, supported by this housing, can be made from a durable, bendable material such as OLED or e-ink technology, which provides clear visibility even when the display is curved. The sensors integrated into the device are capable of detecting not only the wrapped, wrist-worn configuration but also subtle changes in orientation, such as tilting or twisting motions. These sensors work in tandem with the processors to shift the content presentation across the display, ensuring that the information remains within the user's natural line of sight.

By contrast, another embodiment might feature a more robust set of sensors, including gyroscopes and accelerometers, which provide more precise detection of the device's orientation in three-dimensional space. This allows for a more dynamic content presentation that can adapt to a wider range of user movements. The processors in this embodiment are programmed with advanced algorithms that predict the user's viewing angle and adjust the display content, accordingly, providing an intuitive and interactive experience.

A further embodiment could incorporate an image capture device, such as a camera, that works with the processors to adjust the content based on the wearer's gaze direction. This version of the device would use eye-tracking technology to determine where the wearer is looking and move the content to align with their gaze, making it easier to view notifications or read text without the need to adjust the position of the wrist.

In yet another embodiment, the electronic device is designed with environmental adaptability in mind. The sensors and processors are calibrated to account for external factors such as ambient light and temperature, adjusting the display's brightness and contrast to maintain optimal visibility. This ensures that the content remains easily viewable in various lighting conditions, from bright outdoor sunlight to dimly lit indoor spaces.

What's more, an embodiment could be tailored for specific applications, such as fitness tracking or navigation. In this design, the content presentation might include real-time data such as heart rate, speed, or directional arrows, which move along the display to remain in the user's field of view during physical activity. This specialized version of the device would cater to athletes or outdoor enthusiasts who need quick, glanceable access to information without interrupting their activity.

Embodiments of the disclosure offer several advantages that enhance the user experience and functionality of the electronic device. These advantages include the automatic adjustment of the content presentation based on the device's movement, thereby ensuring that the user can easily view the displayed content without the need for manual adjustments. This enhances the user experience by providing a seamless and uninterrupted viewing experience, especially when the device is worn on the wrist.

Secondly, the use of sensors such as inertial measurement units and flex sensors allows for precise detection of the device's angle and orientation. This enables the system to accurately determine the probable viewing area of the screen and adjust the content accordingly. As a result, the content remains within the user's line of sight, improving visibility and reducing the chances of occlusion.

Additionally, the solution offers flexibility in adapting to different form factors and use cases. The device can be worn in various configurations, such as flat, upright, tent, or wrist mode, and the content presentation adjusts accordingly. This versatility allows users to seamlessly transition between different modes and still have optimal visibility of the displayed content.

Moreover, the solution takes into account the camera preview area as a probable viewing area. By adjusting the camera preview angle and displaying the field of view on the device, users can have a better understanding of what the camera is capturing. This feature is particularly useful for photography or videography applications, where users can align their shots more accurately.

Overall, the solution improves the usability and convenience of adaptive wearable display devices by ensuring optimal content visibility and adaptability to different form factors. It enhances the user experience by providing a seamless and intuitive way to interact with the device, making it more user-friendly and versatile. Furthermore, additional advantages will be described in more detail below, and it will be evident to those skilled in the art that further benefits and advantages can be derived from the teachings of this disclosure.

Turning now to FIG. 1, illustrated therein is one explanatory deformable electronic device 100 configured in accordance with one or more embodiments of the disclosure. The deformable electronic device 100 of FIG. 1 is a portable electronic device. In one or more embodiments, the deformable electronic device 100 includes a deformable link assembly 101 comprising a plurality of linkage members. In one or more embodiments, each linkage member includes a corresponding pivot member 103 that allow the deformable electronic device 100 to be selectively deformed by bending or folding. Advantageously, this allows the deformable electronic device 100 to function as an equivalent to multiple devices depending upon the amount of deformation of the deformable link assembly 101.

For example, the deformable electronic device 100 is shown in an undeformed configuration in which the deformable electronic device 100 is generally flat and substantially planar in FIG. 1. In such a configuration, the deformable electronic device 100 can function as a smartphone, palm-top computer, or tablet computer. However, as will be shown below with reference to FIG. 3, in another embodiment the deformable electronic device 100 can be folded into a tent geometric configuration, in a pad orientation, and can accordingly function as a table clock, content viewer, or auxiliary display when such a condition. It should be obvious to those of ordinary skill in the art having the benefit of this disclosure that the deformable electronic device 100 can function as other devices as a function of its physical geometry, including as a gaming device, a media player, or other device.

This illustrative deformable electronic device 100 includes a display 102, which may optionally be touch-sensitive. In one embodiment where the display 102 is touch-sensitive, the display 102 can serve as a primary user interface of the deformable electronic device 100. Users can deliver user input to the display 102 of such an embodiment by delivering touch input from a finger, stylus, or other objects disposed proximately with the display.

In one embodiment, the display 102 is configured as an organic light emitting diode (OLED) display fabricated on a flexible plastic substrate. However, it should be noted that other types of displays would be obvious to those of ordinary skill in the art having the benefit of this disclosure.

In one or more embodiments, an OLED is constructed on flexible plastic substrates can allow the display 102 to become a flexible display 105 in one or more embodiments with various bending radii. For example, some embodiments allow bending radii of between thirty and six hundred millimeters to provide a bendable display. Other substrates allow bending radii of around five millimeters to provide a display that is foldable through active bending. Other flexible displays 105 can be configured to accommodate both bends and folds. In one or more embodiments the flexible display 105 may be formed from multiple layers of flexible material such as flexible sheets of polymer or other materials.

The explanatory deformable electronic device 100 of FIG. 1 also includes a deformable link assembly 101 comprised of a plurality of linkage members. In one or more embodiments, each linkage member includes one or more pivot members 103. Explanatory operation of one or more embodiments of the deformable link assembly 101 is described in commonly assigned U.S. patent application Ser. No. 18/213,679, filed Jun. 23, 2023, entitled “Deformable Electronic Devices and Methods for Constructing the Same,” which is incorporated by reference herein for all purposes.

The pivot members 103, which each include a pivot shaft having its central axis aligned substantially parallel with the surface defined by the display 102, and which each engage a plurality of links that are interleaved in an overlapping arrangement, allow portions of the deformable link assembly 101 to pivot about each linkage member so that the deformable electronic device 100 becomes bendable and/or foldable.

In one or more embodiments, a flexible substrate is situated beneath the display 102. In one or more embodiments, the flexible substrate provides intermediary support structure between the display 102 and the deformable link assembly 101.

In the illustrative embodiment of FIG. 1, the display 102 abuts a major surface of the flexible substrate on an opposite side of the flexible substrate relative to the deformable link assembly 101. In one embodiment, the lower surface of the display 102, or another layer in the mechanical stack-up of the display 102, can be adhered to the flexible substrate on one side of the flexible substrate while the deformable link assembly 101, or alternatively to portions of the deformable link assembly 101, are adhered to the other side of the flexible substrate. In this illustrative embodiment, the display 102 also spans the pivot members 103 of each linkage member. In this illustrative embodiment, the display 102 is flexible so as to deform when the deformable link assembly 101 bends around the pivot members 103.

Features can be incorporated into the deformable electronic device 100. Examples of such features include an optional image capture device 104 or an optional speaker port 129. A user interface component, which may be a button or touch sensitive surface, can also be disposed along a side of an electronic circuit component housing 106. The deformable electronic device 100 can also include one or more connectors 107, which can be an analog connector, a digital connector, or combinations thereof.

A block diagram schematic 110 of the deformable electronic device 100 is also shown in FIG. 1. The block diagram schematic 110 can be configured as a printed circuit board assembly disposed within the electronic circuit component housing 106. Various components can be electrically coupled together by conductors, or a bus disposed along one or more printed circuit boards. A flexible substrate can then span the pivot members 103 to electrically couple electronic circuits situated in the electronic circuit component housing 106 to other components situated within another electronic circuit component housing 127, wherein included, together.

In one or more embodiments, the deformable electronic device 100 includes one or more processors 112. In one embodiment, the one or more processors 112 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the deformable electronic device 100. Each of the application processor and the auxiliary processor(s) can be configured to process and execute executable software code to perform the various functions of the deformable electronic device 100. A storage device, such as memory 113, can optionally store the executable software code used by the one or more processors 112 during operation.

In this illustrative embodiment, the deformable electronic device 100 also includes a communication circuit 114 that can be configured for wired or wireless communication with one or more other devices or networks. The networks can include a wide area network, a local area network, and/or personal area network. The communication circuit 114 may also utilize wireless technology for communication, such as, but are not limited to, peer-to-peer or ad hoc communications such as HomeRF, Bluetooth and IEEE 802.11, and other forms of wireless communication such as infrared technology. The communication circuit 114 can include wireless communication circuitry, one of a receiver, a transmitter, or transceiver, and one or more antennas 115.

In one embodiment, the one or more processors 112 can be responsible for performing the primary functions of the deformable electronic device 100. For example, in one embodiment the one or more processors 112 comprise one or more circuits operable with one or more user interface devices, which can include the display 102, to present, images, video, or other presentation information to a user. The executable software code used by the one or more processors 112 can be configured as one or more modules 116 that are operable with the one or more processors 112. Such modules 116 can store instructions, control algorithms, logic steps, and so forth.

In one embodiment, the one or more processors 112 are responsible for running the operating system environment of the deformable electronic device 100. The operating system environment can include a kernel and one or more drivers, and an application service layer, and an application layer. The operating system environment can be configured as executable code operating on one or more processors or control circuits of the deformable electronic device 100. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the deformable electronic device 100 optionally includes one or more magnet magnetometer pairs 120, operable with the one or more processors 112, to detect a bending operation that causes the deformable link assembly 101 to deform, thereby transforming the deformable electronic device 100 into a deformed geometry, such as that shown in FIGS. 2-7. In one or more embodiments, each magnet magnetometer pair 120 is situated in a linkage member of the plurality of linkage members defining the deformable link assembly 101 such that the magnetometer of each magnet magnetometer pair 120 is situated in a linkage member of the plurality of linkage members and at least one corresponding magnet is situated in another linkage member of the plurality of linkage members that is adjacent to the linkage member in which the magnetometer is situated.

Illustrating by example, if a magnet of one magnet magnetometer pair 120 is situated in linkage member 126, at least one corresponding magnet may be situated in linkage member 128, which is adjacent to linkage member 126. This adjacent positioning of the magnetometer and corresponding magnet of each magnet magnetometer pair 120 allows the one or more processors 112 to identify a deformed geometric configuration of the deformable electronic device 100 from signals received from the magnetometers of the magnet magnetometer pairs 120.

In the illustrative embodiment of FIG. 1, the magnet magnetometer pairs 120 comprise at least three magnet magnetometer pairs. Moreover, in one or more embodiments each magnet magnetometer pair is separated from each other magnet magnetometer pair by at least one linkage member of the plurality of linkage members defining the deformable link assembly 101.

However, more magnet magnetometer pairs 120 can be added as well. For instance, in other embodiments, every linkage member of the deformable link assembly 101 can include either a magnet or a magnetometer of a magnet magnetometer pair 120. Thus, it should be understood that embodiments of the disclosure can have as few as one magnet magnetometer pair 120 or as many as the number of linkage members.

In the illustrative embodiment of FIG. 1, the plurality of linkage members defining the deformable link assembly 101 comprises at least fifteen linkage members. Like the number of magnet magnetometer pairs 120, this number can vary as well. Increasing the number of linkage members allows for tighter bending radii, while decreasing the number of linkage members simplifies the design and reduces the part count necessary to construct the deformable electronic device 100.

In one or more embodiments at least some of the linkage members of the plurality of linkage members defining the deformable link assembly 101 house one or more rechargeable electrochemical cells. In the illustrative embodiment of FIG. 1, each linkage member of the plurality of linkage members defining the deformable link assembly 101 houses a rechargeable electrochemical cell pair.

In one or more embodiments, the magnetometer of odd instances of the linkage members housing the rechargeable electrochemical cell pairs is situated between a first pair of rechargeable electrochemical cells situated within the odd instances of the linkage members housing the rechargeable electrochemical cell pairs. The corresponding magnets of the magnet magnetometer pair 120 of even instances of the linkage members housing the rechargeable electrochemical cell pairs is then situated between a second pair of rechargeable electrochemical cells situated within the even instances of the linkage members housing the rechargeable electrochemical cell pairs.

This “between the cells” positioning of the magnet or magnetometer of each magnet magnetometer pair 120 allows for the determination of a wide range of deformable geometric configurations while using only a small number of magnet magnetometer pairs 120. However, in other embodiments, either the magnetometers or magnets can be situated outside the rechargeable electrochemical cell pairs as well. Other configurations will be obvious to those of ordinary skill in the art having the benefit of this disclosure.

Accelerometers 125 can be used in conjunction with the magnet magnetometer pairs 120. Illustrating by example, a first accelerometer can be positioned in the electronic circuit component housing 106, while a second accelerometer is situated within another electronic circuit component housing 127. In this illustrative embodiment, the electronic circuit component housing 106 is situated to one side of the plurality of linkage members defining the deformable link assembly 101, while the other electronic circuit component housing 127 is situated to another side of the plurality of linkage members defining the deformable link assembly 101.

In one or more embodiments, the one or more processors 112 can use the magnet magnetometer pairs 120 to detect a deformed or undeformed state of the deformable electronic device 100 and can then use the accelerometers 125 to distinguish orientations of those geometric configurations. Illustrating by example, in one or more embodiments the one or more processors 112 are configured to distinguish between the L pad geometric configuration and the L stand geometric configuration, or alternatively between the tent pad geometric configuration and the tent lean back geometric configuration, using signals received from the first accelerometer and the second accelerometer. Techniques for doing this will be described below with reference to FIG. 18. Others will be obvious to those of ordinary skill in the art having the benefit of this disclosure.

In one embodiment, the one or more processors 112 may generate commands or execute control operations based on information received from the various sensors, including the one or more magnet magnetometer pairs 120, the accelerometers 125, the user interface, or the other sensors 121. The one or more processors 112 may also generate commands or execute control operations based upon information received from a combination of the one or more magnet magnetometer pairs 120, the accelerometers 125, the user interface, or the other sensors 121. Alternatively, the one or more processors 112 can generate commands or execute control operations based upon information received from the one or more magnet magnetometer pairs 120 and the accelerometers 125 alone. Moreover, the one or more processors 112 may process the received information alone or in combination with other data, such as the information stored in the memory 113.

In one or more embodiments, the one or more processors 112 are also operable to actuate the image capture device 104 under certain conditions. Illustrating by example, in one or more embodiments the one or more processors 112 can execute a method that actuates the image capture device 104 in the electronic device 100 that causes the image capture device 104 to capture visual content such as images and videos.

In one or more embodiments, the image capture device 104 comprises of one or more cameras with various recording modes, including a video recording mode. In one or more embodiments, the one or more processors 112 control the image capture device 104, thereby instructing it to enter or exit the video recording mode based on specific detected conditions. This actuation capability allows the electronic device 100 to function like a camcorder when it is wrapped around a user's wrist in a specific geometric form factor, and optionally lifted into a camcorder support condition.

In one or more embodiments, one or more sensors 121 are embedded within the electronic device 100 and are configured to detect a variety of conditions and inputs. These sensors may include, but are not limited to, accelerometers, gyroscopes, magnetometers, proximity sensors, and flex sensors, which can include the magnet magnetometer pairs 120.

In one or more embodiments, the one or more sensors 121 can be capable of detecting the wrapped geometric form factor defined by the flexible display 102 supported by a deformable housing, which is indicative of the electronic device 100 being worn on the user's wrist. Additionally, the one or more sensors 121 can be operable to detect gesture input that indicates a camcorder support condition is supporting the electronic device 100 in three-dimensional space while the wrapped geometric form factor is occurring. This detection is then used, in one or more embodiments, to enable the image capture mode of operation of the image capture device 104.

The one or more processors 112, which can serve as the central processing unit(s) of the electronic device 100, execute instructions and coordinating the operations of various components, examples of which can be stored as modules 116 within the memory 113. The one or more processors 112 are operable with the one or more sensors 121 to process the detected conditions, such as the wrapped, wrist-worn geometric configuration and changes in orientation in three-dimensional space.

Upon detecting these conditions, in one or more embodiments the one or more processors 112 are configured to move content being presented on a portion of the flexible display 102 from a first location to a second location as a function of a change in orientation of the electronic device 100 in three-dimensional space. Illustrating by example, if content is initially presented in a default location at a predefined portion of the flexible display 102, and one or more sensors 121 detect gesture input translating the electronic device 100 in three-dimensional space while the wrapped geometric form factor is occurring, in one or more embodiments the one or more processors 112 will move the content to a different portion of the flexible display 102 that is selected as a function of a change in orientation of the electronic device 100 in three-dimensional space due to the translation.

Advantageously, this allows the content to remain visible to a user regardless of how they move their arm in three-dimensional space. In one or more embodiments, the one or more processors 112 can estimate a probably visible location for the content relative to a gaze of a wearer of the electronic device 100. Once this occurs, the second location may be the probable visible location of the flexible display 102.

In one or more embodiments, the one or more processors 112 can use an image capture device 104 to detect a gaze cone of a wearer of the electronic device 100. In one or more embodiments, the second location is situated within that gaze cone such that the user can continue to see the content being presented after moving their arm in three-dimensional space.

In one or more embodiments, the first location and second location are both on the top of the electronic device 100. Said differently, in one or more embodiments the first location and the second location span portions of the flexible display where a direction of gravity intersects the flexible display 102 orthogonally. Thus, if a person inverts their wrist, the content still stays on the top of the electronic device 100 with the direction of gravity intersecting the apex of the flexible display 102. In such a situation, the first location, prior to the inversion, would span a portion of the flexible display 102 where the direction of gravity intersects a surface of the portion of the flexible display 102 orthogonally, while the second location would span another portion of the flexible display 102 where the direction of gravity intersects another surface of another portion of the flexible display orthogonally.

However, in other embodiments, such as when the user raises their wrist such that the direction of gravity passes through a looped defined by the wrapped geometric form factor, the direction of gravity would fail to intersect the flexible display 102 after the translating. In still other embodiments, the second situation is always situated atop the radius bone of the wrist of a wearer of the electronic device 100.

Since the wrapped geometric form factor can be created both when the electronic device 100 is positioned about a wrist and when there is no wrist within the wrapped geometric form factor, in one or more embodiments moving the content only occurs when the wrapped geometric form factor is wrist-worn. Said differently, in one or more embodiments the one or more sensors 121 can identify whether the wrapped geometric form factor is in a wrist-worn condition. In one or more embodiments, the movement of content along the flexible display 102 only occurs when the wrist-worn condition is occurring. Other examples and features offered by the electronic device 100, which comprises a device housing comprising a plurality of linkage members, a flexible display 102 supported by the deformable housing, one or more sensors, such as those defined by the one or more magnet magnetometer pairs 120, to determine a wrapped, wrist-worn geometric configuration of the electronic device 100 and one or more other sensors 121 to detect when the electronic device changes 100 orientation in three-dimensional space, and one or more processors operable to cause a content presentation on the flexible display to move along the flexible display as a function of changes in the orientation of the electronic device 100 in three-dimensional space while the electronic device 100 is in the wrapped, wrist-worn geometric configuration will be described below. Still others will be obvious to those of ordinary skill in the art having the benefit of this disclosure.

In one or more embodiments, the electronic device 100 comprises the deformable housing, the flexible display 102, one or more sensors to detect a wrapped geometry, such as those defined by magnet magnetometer pairs 120, one or more other sensors 121, an image capture device 104, and one or more processors 112. In one or more embodiments, the deformable housing includes a plurality of linkage members found in a deformable link assembly 101 and supports the flexible display 102. This deformable link assembly 101 allows the flexible display 102 to maintain a wrapped, wrist-worn geometric configuration, one example of which will be described below with reference to FIG. 8. This configuration is detectable by the one or more sensors defined by magnet magnetometer pairs 120, which are operable to determine when the electronic device 100 assumes the wrapped geometric form factor indicative of being worn on a user's wrist.

The flexible display 102, supported by the deformable housing, is capable of presenting visual content and can be manipulated into various geometric configurations to suit different use cases. The one or more processors 112 facilitate movement of content along the flexible display 102 when the electronic device 100 translates in three-dimensional space. The one or more sensors defined by magnet magnetometer pairs 120 work in conjunction with the flexible display 102 to facilitate the detection of the electronic device's geometric configuration.

The one or more other sensors 121 are operable to detect when the electronic device 100 is supported in a camcorder orientation in three-dimensional space. These sensors 121 may include accelerometers, gyroscopes, and other motion-detecting components that can sense the orientation and movement of the electronic device 100 relative to the user's body and the surrounding environment.

The image capture device 104 is a component of the electronic device 100 that is responsible for capturing visual content, such as photos and videos. The image capture device 104 is operable with the one or more processors 112, which serve as the central processing unit(s) for the electronic device 100. These one or more processors 112 are responsible for executing instructions, processing data, and controlling the operation of the electronic device 100. The one or more processors 112 are operable with one or more sensors and one or more other sensors to cause a content presentation on the flexible display 102 to move along the flexible display 102 as a function of changes in the orientation of the electronic device 100 in three-dimensional space while the electronic device 100 is in a wrapped, wrist-worn geometric configuration.

In one or more embodiments, when the image capture device 104 is activated, it enters a video recording mode of operation in response to the electronic device 100 being supported in a camcorder orientation while the electronic device 100 is in the wrapped, wrist-worn geometric configuration. This mode of operation is facilitated by the one or more processors 112, which work in concert with the one or more sensors defined by magnet magnetometer pairs 120 and the one or more other sensors 121. In one or more embodiments, when this occurs the one or more processors 112 are further configured to cause the flexible display 102 to present draw lines with the content presentation, the draw lines indicating a field of view of the image capture device 104. Additionally, the one or more processors 112 are operable to determine a direction of gaze from a wearer of the electronic device 100, wherein the one or more processors 112 cause the content presentation to initially be presented within the direction of gaze from the wearer.

The flexible display 102 supported by the deformable housing of the electronic device 100 is capable of presenting content in various locations depending on the orientation and configuration of the electronic device 100. The flexible display 102 is designed to accommodate the wrapped, wrist-worn geometric configuration of the electronic device 100, allowing for a seamless and continuous display surface that can conform to the shape of a user's wrist. The flexible display 102 is also involved in presenting content in a first location and moving the content to a second location as a function of a change in orientation of the electronic device 100 in three-dimensional space resulting from translating gestures.

In one or more embodiments, the image capture device 104 operates with the one or more processors 112 to generate a content presentation in a preview mode of operation. The image capture device 104 determines a direction of gaze from a wearer of the electronic device 100. The one or more processors 112 cause the content presentation to initially be presented within the direction of gaze from the wearer, as detected by the image capture device 104. Furthermore, the image capture device 104, in conjunction with the one or more processors 112, enables the presentation of draw lines with the content presentation. These draw lines indicate the field of view of the image capture device 104, providing visual guidance to the wearer regarding what the image capture device 104 is currently aimed at or capturing.

The one or more other sensors 121 may further include a microphone, an earpiece speaker, a second loudspeaker, and a user interface component such as a button or touch-sensitive surface. The one or more other sensors 121 may include one or more of an accelerometer, gyroscope, image capture device, and/or display touch sensors to determine whether the deformable electronic device 100 is being held by a first side or a second side in a portrait mode.

The one or more other sensors 121 may also include key selection sensors, proximity sensors, a touch pad sensor, a touch screen sensor, a capacitive touch sensor, and one or more switches. Touch sensors may be used to indicate whether any of the user actuation targets present on the display 102 are being actuated. Alternatively, touch sensors disposed in the deformable electronic device 100 can be used to determine whether the deformable electronic device 100 is being touched at side edges or major faces of the deformable link assembly 101. The touch sensors can include surface and/or housing capacitive sensors in one embodiment. The other sensors 121 can also include audio sensors and video sensors (such as a camera).

The other sensors 121 can also include motion detectors, such as one or more accelerometers or gyroscopes. For example, an accelerometer may be embedded in the electronic circuitry of the deformable electronic device 100 to show vertical orientation, constant tilt and/or whether the deformable electronic device 100 is stationary. A gyroscope can be used in a similar fashion.

Other components 122 operable with the one or more processors 112 can include output components such as video outputs, audio outputs, and/or mechanical outputs. Examples of output components include audio outputs such as speaker port 129, earpiece speaker, or other alarms and/or buzzers and/or a mechanical output component such as vibrating or motion-based mechanisms. Still other components will be obvious to those of ordinary skill in the art having the benefit of this disclosure.

In one or more embodiments, the deformable electronic device 100 comprises a plurality of energy storage devices 123. In one or more embodiments, each energy storage device of the plurality of energy storage devices 123 comprises a rechargeable electrochemical cell. In one or more embodiments, the plurality of energy storage devices 123 include a pair of energy storage devices situated in each linkage member of the plurality of linkage members defining the deformable link assembly 101.

In one or more embodiments, each pair of energy storage devices of the plurality of energy storage devices 123 situates in a corresponding linkage member on a one-to-one basis, with a pair of energy storge devices 123 situated within a corresponding linkage member. In other embodiments, a single energy storage device of the plurality of energy storage devices 123 situates in a corresponding linkage member on a one-to-one basis. In still other embodiments, only some of the linkage members of the plurality of linkage members defining the deformable link assembly 101 will house energy storage devices. Other configurations will be obvious to those of ordinary skill in the art having the benefit of this disclosure.

In the illustrative embodiment of FIG. 1, the plurality of energy storage devices 123 are situated on a rear side of the flexible substrate supporting the display 102. In this example, the plurality of energy storage devices 123 are situated between the electronic circuit component housing 106 to other components situated within another electronic circuit component housing 127. In one or more embodiments, each pair of energy storage devices of the plurality of energy storage devices 123 substantially spans a width of the deformable electronic device.

Each energy storage device of the plurality of energy storage devices 123 can take a variety of forms. In an illustrative embodiment, each energy storage device of the plurality of energy storage devices 123 can comprise an electrochemical cell, which is optionally rechargeable. For instance, the plurality of energy storage devices 123 can each comprise a lithium-ion, lithium-polymer, or other type of rechargeable cell. Other examples of energy storage devices suitable for use with embodiments of the disclosure will be obvious to those of ordinary skill in the art having the benefit of this disclosure. For instance, in other embodiments the plurality of energy storage devices 123 may be a supercapacitor, and so forth.

In one or more embodiments, a first pair of energy storage devices is situated in a first linkage member, with a second pair of energy storages device situated in a second linkage member, and so forth. In one or more embodiments, an electrical conductor couples the energy storage devices of the plurality of energy storage devices 123 together and/or to the one or more processors 112.

Charging circuitry 124 can be included to selectively individual, subsets, or all of the plurality of energy storage devices 123 when depleted. In one or more embodiments, the charging circuitry 124 comprises a charging node that is coupled to each energy storage device of the plurality of energy storage devices 123.

In one or more embodiments, the charging circuitry 124 includes a switch that is electrically coupled between the conductor coupling the plurality of energy storage devices 123. Opening the switch disconnects the conductor from the plurality of energy storage devices 123, while closing the switch couples the plurality of energy storage devices 123 to the components of the block diagram schematic 110.

It is to be understood that FIG. 1 is provided for illustrative purposes only and for illustrating components of one deformable electronic device 100 in accordance with embodiments of the disclosure and is not intended to be a complete schematic diagram of the various components required for an electronic device. Therefore, other deformable electronic devices in accordance with embodiments of the disclosure may include various other components not shown in FIG. 1 or may include a combination of two or more components or a division of a particular component into two or more separate components, and still be within the scope of the present disclosure.

A user can perform a bending operation upon the deformable electronic device 100. For example, a user can apply force at the first end 108 and the second end 109 of the deformable electronic device 100 to pivot linkage members of the deformable link assembly 101 relative to other linkage members of the deformable link assembly 101. This method of deforming the deformable link assembly 101 allows the user to simply and quickly bend the deformable electronic device 100 into a desired geometric configuration. Examples of common geometric configurations include an L geometric configuration, a tent geometric configuration, a hook geometric configuration, and a wrapped geometric configuration. Others will be obvious to those of ordinary skill in the art having the benefit of this disclosure.

In other embodiments, rather than relying upon the manual application of force, the deformable electronic device 100 can include a mechanical actuator to deform the deformable link assembly 101 around the pivot members 103 of each linkage member. For example, a motor or other mechanical actuator can be operable with structural components to deform the deformable link assembly 101 around the pivot members 103 of the linkage members to predetermined angles or geometric alignments in one or more embodiments. The inclusion of a mechanical actuator allows a precise bend angle to be repeatedly achieved without the user having to make adjustments in attempting to achieve the same. However, as the inclusion of a mechanical actuator can increase cost, in other embodiments this component will be omitted.

It should be noted that in one or more embodiments, the display 102 has a compliance coefficient that can be used advantageously to help counter the bending operation. Illustrating by example, when the bending operation transforms the deformable electronic device 100 to a bent configuration, one example of which is shown below with reference to FIG. 3, in one or more embodiments the mechanical layers of the display 102 are loaded by the bending operation and work to bias portions of the deformable link assembly 101 back to the open position of FIG. 1.

Moreover, in one or more embodiments a thin stainless-steel plate (approximately 0.04 millimeters in thickness) forms one layer of the display 102 and will increase the loading. This mechanical loading of the layers of the display 102 can be used to help the user transform the deformable electronic device 100 from folded or partially folded configurations to unfolded configurations in one or more embodiments. The modulus of the display 102 can range from 40-300 giga-Pascals in one or more embodiments.

Regardless of whether the bending operation is a manual one or is instead one performed by a mechanical actuator, it results in the display 102 being deformed by one or more bends about the linkage members. Turning now to FIGS. 2-7, illustrated therein are three illustrative results of bending operations.

In the illustrative embodiment of FIG. 2, the deformable electronic device 100 has been deformed into an L-shape geometric configuration. Additionally, the L-shape geometric configuration has been placed on a table or other flat surface such that the minor planar surface of display 102 defining the “L” abuts the surface. This is known as a “L stand” geometric configuration, with the deformable electronic device 100 having a single bend. This bent configuration can make the display 102 easier for the user to view since they do not have to hold the deformable electronic device 100 in their hands.

In this illustrative embodiment, the display 102 has a single bend about the linkage members 200. However, in other embodiments, the display 102 can be deformed with a plurality of bends about the linkage members 200. Other configurations will be obvious to those of ordinary skill in the art having the benefit of this disclosure.

In one embodiment, the one or more processors (112) of the deformable electronic device 100 are operable to detect that a bending operation is occurring from signals from the magnetometers of the magnet magnetometer pairs (120). Said differently, in one or more embodiments the one or more processors (112) are configured to determine whether the deformable electronic device 100 is deformed, and into what geometric configuration, from signals from the magnetometers of the magnet magnetometer pairs (120). This can be done in conjunction with other signals from the accelerometers (125).

Where, for instance, the deformable electronic device 100 comprises a first accelerometer situated to one side of the plurality of linkage members and a second accelerometer situated to a second side of the plurality of linkage members, the one or more processors (112) are configured to determine, when the deformable electronic device 100 is deformed as shown in FIG. 2, whether the deformable electronic device 100 is in a pad orientation (the deformable electronic device 100 is shown in a L pad geometric configuration in FIG. 6), a stand orientation, or, in the case of tent folds such as that shown in FIG. 3, whether the deformable electronic device 100 is in a tent pad orientation (shown in FIG. 3) or a tent lean back orientation (the deformable electronic device 100 is shown in a tent lean back geometric configuration in FIG. 7). Techniques for doing this are further described below with reference to FIG. 18.

In FIG. 2, the one or more processors (112) are operable to determine the deformable electronic device 100 is in a L stand configuration from signals from the magnet magnetometer pair (120) and other signals from the accelerometers (125). The one or more processors (112) can detect other geometric configurations of the deformable electronic device 100 as well, one example of which is the hook geometric configuration shown in FIG. 5.

In one or more embodiments, the one or more processors (112) can partition the display 102 of the deformable electronic device 100 as another function of the geometric alignment of the deformable link assembly (101) resulting from the bending operation. For example, in the illustrative embodiment of FIG. 2 the display 102 has been partitioned into a first portion that is visible and a second portion (facing into the surface upon which the deformable electronic device 100 rests), with each portion being disposed on opposite sides of the stand bend. In one or more embodiments, the one or more processors (112) can detect a bend amount as well using the magnet magnetometer pairs (120) and/or accelerometers (125).

In one or more embodiments, the one or more processors (112) of the electronic device are operable to, when the display 102 is deformed by one or more bends, present a first image on a first portion of the display 102, while presenting a second image on a second portion of the display 102. If, for example, the deformable electronic device 100 were turned such that the first end (108) and the second end (109) were resting on the surface, which is known as a “pad” orientation, and which is shown in FIG. 6, the deformable electronic device 100 would resemble an offset tent with a first portion of the display 102 visible from a first side of the bend and a second portion of the display 102 visible from a second side of the bend.

When the bend is made in the middle, rather than in an offset location such as that shown in FIG. 2, the L geometric configuration transforms to a “tent” geometric configuration. One example of such a tent geometric configuration is shown in FIG. 3. As shown in FIG. 3, the deformable electronic device 100 has been bent further to resemble a playing card bent into a “tent” configuration. The tent configuration of FIG. 3 is in a “pad” orientation because the first end (108) and the second end (109) of the deformable electronic device 100 are resting on a surface. This “tent pad” geometric configuration makes the display 102 easier to see from above.

FIG. 4 illustrates the deformable electronic device 100 when deformed into a “wrapped” geometric configuration. When in the wrapped geometric configuration, the deformable electronic device 100 can even be worn on a wrist. When worn on a wrist, the wrapped geometric configuration becomes a wrist-worn wrapped geometric configuration. Whether the electronic device 100 is positioned on a wrist can be determined with touch sensors situated along the deformable housing.

In one or more embodiments, the wrapped geometric configuration can be configured with different radii to accommodate different size wrists. In one or more embodiments, the deformable electronic device 100 can be deformed into at least six different wrapped geometric configurations, each having a smaller radius than the one before to accommodate smaller and smaller wrists.

In one or more embodiments, the plurality of linkage members 200 define a multi-link hinging mechanism for the deformable electronic device 100. In FIGS. 1-7 the linkage members 200 are all similarly configured with links separating each pivot member (103) from another. The linkage members 200 defining the deformable link assembly 101 are attached to a rear major face of the flexible substrate supporting the display 102.

Turning now to FIG. 8, illustrated therein is a user, identified as user 800, wearing an explanatory electronic device 100 configured in accordance with one or more embodiments of the disclosure on their wrist while in a wrapped geometric form factor. The electronic device 100 is shown in a wrapped geometric configuration, specifically designed to be worn comfortably on the user's wrist. This configuration allows the electronic device 100 to adapt to the shape of the wrist, providing a secure and ergonomic fit.

To detect the wrist-worn wrapped geometric configuration, the electronic device 100 is equipped with one or more sensors. These sensors are strategically placed within the device to capture and analyze data related to the device's position and orientation. By monitoring the data from these sensors, one or more processors (112) of the electronic device 100 can determine if it is being worn on the user's wrist in the intended wrapped configuration.

One way the sensors can detect the wrist-worn wrapped geometric configuration is by utilizing magnet magnetometer pairs (120). These pairs of sensors can measure the magnetic field strength and orientation, allowing the electronic device 100 to detect the specific arrangement of the device's components when wrapped around the wrist. By analyzing the magnetic field data, the electronic device 100 can confirm that it is in the desired wrapped configuration.

Additionally, other sensors (121) integrated into the electronic device 100 can contribute to detecting the wrist-worn wrapped geometric configuration. For example, accelerometers and gyroscopes can sense the device's movement and orientation in three-dimensional space. By analyzing the data from these sensors, the device can determine if it is in the appropriate position and orientation to be considered in the wrapped configuration on the user's wrist.

Overall, the combination of magnet-magnetometer pairs and other sensors allows the electronic device 100 to accurately detect and confirm the wrist-worn wrapped geometric configuration. This ensures that the device enters the desired mode of operation, such as modes that automatically move content in response to gesture input translating the electronic device 100 in three-dimensional space are actuated when it is securely and comfortably worn on the user's wrist.

Embodiments of the disclosure contemplate that users will want uninterrupted visibility of content to appear on the electronic device 100 while in the wrist-worn, wrapped geometric form factor. Advantageously, embodiments of the disclosure provide a method for detecting, using one or more processors, a wrapped geometric form factor defined by the flexible display and deformable housing of the electronic device 100. One or more other sensors then detect gesture input translating the electronic device 100 in three-dimensional space while the wrapped geometric form factor is occurring. In one or more embodiments, one or more processors of the electronic device 100 then cause content being presented on the flexible display 102 supported by the deformable housing to move in proportion to the rotational and/or lifting operation defining the gesture input.

Turning now to FIG. 9, illustrated therein is one such method 900. Embodiments of the disclosure contemplate that when the electronic device 100 is in the wrist-worn, wrapped geometric form factor, a user can move their arm with content remaining visible so that their arm has free movement without losing content visibility.

Beginning at step 901, one or more sensors of the electronic device detect a geometric form factor of an electronic device having a deformable device housing. Decision 902 then determines whether the geometric form factor is deformed to a wrapped geometric form factor. Where it is, decision 903 determines whether the electronic device is worn on a wrist. Where these conditions are true, the method 900 proceeds to step 904. Otherwise, the method 900 returns to step 901.

At step 904, the method optionally initially presents content on a flexible display supported by a deformable housing of an electronic device in a default position. This default position is designed to provide an optimal viewing experience for the user. The default position can be selected from a variety of options, each offering a unique location for the content presentation.

One option for the default location is the predefined portion of the display, represented by element 908. This predefined portion is situated at a specific area of the flexible display, strategically chosen to ensure maximum visibility and accessibility for the user. By presenting the content in this predefined portion, the electronic device can provide a consistent and intuitive user experience.

Another option for the default location is such that the content is visible from a predefined direction, represented by element 909. This predefined direction determines the orientation of the content presentation on the flexible display relative to a default expected orientation to a user. Illustrating by example, when the electronic device is worn like a watch, the predefined direction can be upward and away from the radius and ulna bones of the wearer. By aligning the content with a predefined direction, the electronic device can ensure that the user can easily interact with and consume the displayed information.

A further option for the default location is the predefined orientation relative to gravity direction, represented by element 910. This predefined orientation takes into account the gravitational forces acting on the electronic device. By aligning the content presentation so as to have a predefined relationship with the direction of gravity as it intersects the electronic device, the electronic device can provide a natural and comfortable viewing experience for the user.

Element 911 represents the option of utilizing an imager to detect the user's location. By using an image capture device, the electronic device can determine the position and orientation of the user, allowing for a personalized and tailored content presentation.

Element 912 represents the option of gaze detection. By detecting the direction of the user's gaze, the electronic device can adjust the content presentation to align with the user's line of sight. This ensures that the user can easily view and interact with the displayed content without straining their eyes or adjusting their posture.

Finally, element 913 represents the option of user input. By allowing the user to provide input, such as through gestures or commands, the electronic device can customize the default location of the content presentation based on the user's preferences and needs.

In summary, step 904 of FIG. 9 involves initially presenting content on a flexible display supported by a deformable housing of an electronic device in a default position. This default position can be selected from various options, including predefined portions of the display, predefined directions, predefined orientations relative to gravity, user location detection, gaze detection, and user input. Each option offers a unique way to optimize the content presentation and enhance the user experience.

At step 905, the method 900 involves monitoring the orientation of the electronic device in three-dimensional space. This step allows one or more processors of the electronic device determining the position and movement of the device, which in turn affects the presentation of content on the flexible display. There are several options available to accomplish this monitoring of orientation.

One option is to utilize one or more sensors, including those described above with reference to FIG. 1. These sensors can include accelerometers, gyroscopes, magnetometers, or a combination of these, which are capable of detecting changes in the device's position and orientation. By continuously monitoring the data from these sensors, the electronic device can accurately track its orientation in three-dimensional space.

Another option is to incorporate one or more other sensors. These sensors can include proximity sensors, ambient light sensors, or any other suitable sensors that can provide additional information about the device's surroundings. By gathering data from these sensors, the electronic device can further enhance its understanding of the user's environment and adjust the content presentation accordingly.

Additionally, the electronic device can employ image capture devices to monitor the orientation. These image capture devices can include cameras or depth sensors that capture visual information about the device's surroundings. By analyzing the captured images or depth data, the electronic device can determine the orientation of the device relative to its surroundings.

Furthermore, the electronic device can utilize specialized components, such as inertial measurement units. Inertial measurement units combine multiple sensors, such as accelerometers, gyroscopes, and magnetometers, into a single integrated unit. This allows for more accurate and reliable monitoring of the device's orientation in three-dimensional space.

In summary, step 905 of FIG. 9 involves monitoring the orientation of the electronic device in three-dimensional space. This can be achieved through various options, including the use of sensors, other sensors, image capture devices, or specialized components like inertial measurement units. By continuously monitoring the device's orientation, the electronic device can ensure precise and responsive adjustments to the content presentation on the flexible display, providing an optimal viewing experience for the user.

Decision 906 detects whether gesture input has translated the electronic device in three-dimensional space while the wrapped geometric form factor is occurring. In one or more embodiments, decision 906 detects whether a rotational and/or lifting operation has changed the orientation in the three-dimensional space. Where it has, the method 900 moves to step 907. Otherwise, it returns to step 905.

At step 907, in response to at least a first sensor detecting a wrapped geometry at decision 902, about a wrist at decision 903, and at least a second sensor detecting a rotational and/or lifting operation, the one or more processors of the electronic device cause content presented on the flexible display supported by the deformable housing to move along the flexible display. In one or more embodiments, this movement occurs in proportion to the rotational and/or lifting operation defining the gesture input detected at step 905.

Embodiments of the disclosure advantageously allow a user to elegantly maintain visibility of content presented on the flexible display without having to rely upon physical keys, and without having to awkwardly drag the content around a deformed electronic device. The gesture-based translation of content allows for a more natural and “easy to learn” capability for the system. Other advantages offered by embodiments of the disclosure will be described below. Still others will be obvious to those of ordinary skill in the art having the benefit of this disclosure.

Turning now to FIG. 10, illustrated therein are one or more method steps illustrating the method (900) of FIG. 9 in practice. Beginning at step 1001, a user 800 is wearing an electronic device 100 configured in accordance with one or more embodiments of the disclosure. At step 1001, the one or more sensors determine that the wrist-worn, wrapped geometric form factor of the electronic device 100 is occurring.

As previously described, the electronic device 100 comprises a deformable housing having a plurality of linkage members, a flexible display supported by the deformable housing, one or more sensors operable to determine the wrist-worn, wrapped geometric form factor of the electronic device 100, and one or more sensors operable to detect when the electronic device 100 changes orientation in three-dimensional space. In one or more embodiments, the electronic device 100 also includes an image capture device and one or more processors operable with the one or more sensors, the one or more other sensors, and the image capture device.

At step 1002, one or more processors of the electronic device 100 present content on the flexible display of the electronic device 100 in a first location. In one or more embodiments, the first location is a default location situated at a predefined portion of the flexible display. As described above with reference to FIG. 9, the default location can be selected in a variety of ways so that the electronic device 100 can be customized by the user 800. An example of this is shown at step 1003, where content 1008 is being presented at a first location 1009 of the flexible display of the electronic device 100.

Step 1004 then monitors for the orientation of the electronic device 100 changing using an orientation detector. In one or more embodiments, when the user 800 delivers gesture input to the electronic device 100, such as by performing a lifting operation elevating the electronic device 100 from a first position to a second position in three-dimensional space.

Decision 1005 then determines whether the orientation changes, with step 1006 causing the content 1008 to move to a second location on the flexible display 102 of the electronic device 100. As shown at step 1007, in this illustrative embodiment the user 800 has twisted their wrist from where the top of the wrist was facing upward at step 1003, and the bottom of the wrist is facing upward at step 1007. Consequently, the one or more processors of the electronic device 100 have moved the content 1008 to a second location 1010 that is different from the first location 1009, as shown at step 1007. Said differently, the gesture input being applied between step 1003 and step 1007 comprises a rotation about a central axis (extending along the arm of the user 800) of the wrapped, wrist-worn geometric configuration of the electronic device 100. In this illustrative embodiment, the movement of the content results in an outward facing vector (which would face outward from the page in FIG. 9) to remain oriented in a constant direction (upward) during the rotational (or lifting if it had been applied) operation defining the user input.

Embodiments of the disclosure are particularly useful when the electronic device 100 is operating in an image capture mode. In this mode, the electronic device 100 utilizes its image capture device, such as a camera, to capture images or videos. The ability to adjust the content presentation on the flexible display based on the device's orientation becomes especially valuable in this context.

When capturing images or videos, it is crucial to have a clear and unobstructed view of the subject. By monitoring the orientation of the electronic device 100 in three-dimensional space, embodiments of the disclosure ensure that the content presentation on the flexible display 102 is optimized for capturing the desired subject. For example, if the user 800 wants to capture a landscape view, the electronic device 100 can adjust the content presentation to align with the horizon, providing a level and balanced composition.

Furthermore, the ability to present draw lines (described below) indicating the field of view of the image capture device enhances the user's ability to frame the shot accurately. These draw lines act as visual guides, helping the user align the device and capture the desired scene within the frame. This feature is particularly beneficial when capturing images or videos that require precise composition or alignment, such as architectural photography or product shots.

Moreover, by utilizing the image capture device to detect the direction of the user's gaze, embodiments of the disclosure can further enhance the image capture experience. The content presentation can be initially presented within the direction of the user's gaze, ensuring that the user can easily view the subject and make necessary adjustments to the composition or focus.

In summary, embodiments of the disclosure are especially useful when the electronic device 100 is operating in an image capture mode. The ability to adjust the content presentation on the flexible display based on the device's orientation, present draw lines indicating the field of view, and align the content with the user's gaze significantly enhance the user's ability to capture high-quality images or videos. These features ensure optimal framing, composition, and focus, resulting in an improved image capture experience. Turning now to FIG. 11, illustrated therein are one or more method steps illustrating how embodiments of the disclosure can be used in an image capture operation mode.

Beginning at step 1101, the user 800 is again wearing an electronic device 100 configured in accordance with one or more embodiments of the disclosure. At step 1102, the one or more sensors determine that the wrist-worn, wrapped geometric form factor of the electronic device 100 is occurring. In this illustrative example, the one or more sensors determine that the wrist-worn, wrapped geometric form factor of the electronic device 100 is occurring while the electronic device 100 is operating in an image capture operation mode.

At step 1103, the one or more processors of the electronic device 100 present content 1008 at a first location 1009 on the flexible display of the electronic device 100. In this illustrative example, the content 1008 comprises a preview view of an image capture device of the electronic device 100. In one or more embodiments, the content presentation is generated by a preview mode of operation of the image capture device.

Desiring to get a better view of his dog, Buster, at step 1105, the user 800 transitions the electronic device 100 in three-dimensional space toward a camcorder support condition. In this illustrative embodiment, the lifting operation has moved the electronic device 100 to a position where a gravity direction 1112 passes through a loop defined by the wrapped geometric form factor, and as shown at step 1105, through a width 1113 of the electronic device. At decision 1106, one or more sensors of the electronic device 100 detect this gesture input indicating that the electronic device 100 is being transitioned to a camcorder support condition, as shown at step 1108.

At step 1107, the one or more processors of the electronic device 100 move the viewfinder preview image from the first location 1009 shown at step 1104 to a second location 1109 shown at step 1108. In this illustrative embodiment, the one or more processors have moved the content 1008 around the electronic device 100 by about forty-five degrees such that the viewfinder image is situated atop the radius bone of a wrist of the user 800.

In one or more embodiments when the electronic device 100 is operating in an image capture operation mode, step 1107 can also identify the field of view of the image capture device. Illustrating by example, as shown at step 1108 the viewfinder content 1110 is being presented along with draw lines 1111 that indicate a field of view of the electronic device 100. By displaying these draw lines 111, the electronic device 100 provides the user 800 with a clear understanding of what the image capture device is currently aiming at or capturing.

The draw lines 1111 are particularly beneficial in various scenarios. For instance, when capturing photographs or videos, the user 800 can use the draw lines 1111 to align the electronic device 100 and frame the shot accurately. The draw lines 1111 act as guides, helping the user position the electronic device 100 in such a way that the desired subject is within the field of view. This ensures that the captured image or video includes the intended elements and maintains the desired composition.

Additionally, the draw lines 1111 can assist in capturing panoramic or wide-angle shots. By extending the draw lines 111 across the flexible display, the electronic device 100 provides a visual representation of the wider field of view that the image capture device can capture. This allows the user 800 to adjust their positioning and capture a broader scene, resulting in more immersive and expansive photographs or videos.

Furthermore, the draw lines 1111 can be useful in scenarios where precise alignment or positioning is required. For example, in architectural photography or product photography, the draw lines 111 can help the user 800 align the electronic device 100 with specific lines or edges in the scene. This ensures that the captured image maintains straight lines and accurate proportions, enhancing the overall quality and professionalism of the photograph.

In summary, the draw lines 111 presented on the flexible display in step 1108 of FIG. 11 provide valuable visual guidance to the user 800. They assist in framing shots accurately, capturing panoramic or wide-angle scenes, and achieving precise alignment in various photography or videography scenarios. By leveraging these draw lines 111, the electronic device 100 enhances the user's ability to capture visually appealing and well-composed images or videos.

Advantageously, the method of FIG. 11 allows for an intuitive and seamless method to transition their hand and forearm in three-dimensional without losing sight of output of a viewfinder mode of the image capture device.

Turning now to FIG. 12, illustrated therein are various embodiments of the disclosure. The embodiments of FIG. 12 are shown as labeled boxes in FIG. 12 due to the fact that the individual components of these embodiments have been illustrated in detail in FIGS. 1-11, which precede FIG. 12. Accordingly, since these items have previously been illustrated and described, their repeated illustration is no longer essential for a proper understanding of these embodiments. Thus, the embodiments are shown as labeled boxes.

At 1201, a method in an electronic device comprises detecting, with one or more sensors, a wrapped geometric form factor defined by a flexible display supported by a deformable housing. At 1201, the method comprises presenting, with one or more processors, content on the flexible display in a first location.

At 1201, the method comprises also detecting, with one or more other sensors, gesture input translating the electronic device in three-dimensional space while the wrapped geometric form factor is occurring. At 1201, the method comprises moving, by the one or more processors, the content on the flexible display in response to the translating to a second location as a function of a change in orientation of the electronic device in three-dimensional space resulting from the translating.

At 1202, the first location of 1201 is a default location situated at a predefined portion of the flexible display. At 1203, the method of 1202 further comprises estimating a probable visible location for the content relative to a gaze of a wearer of the electronic device. At 1203, the second location is the probable visible location situated at another portion of the flexible display.

At 1204, the method of 1201 further comprises detecting, using an image capture device, a gaze cone of a wearer of the electronic device, wherein the first location is situated within the gaze cone. At 1205, the first location of 1201 spans at a portion of the flexible display where a direction of gravity intersects a surface of the portion of the flexible display orthogonally. At 1206, the second location of 1205 spans another portion of the flexible display where the direction of gravity intersects another surface of another portion of the flexible display orthogonally. At 1207, the direction of gravity of 1205 fails to intersect the flexible display after the translating.

At 1208, the second location of 1207 is situated atop a radius bone of the wrist of a wearer of the electronic device. At 1209, the content of 1208 comprises a preview view of an image capture device of the electronic device. At 1210, the method of 1209 further comprises presenting draw lines with the content. At 1210, the draw lines indicating a field of view of the image capture device.

At 1211, the method of 1201 further comprises identifying, with the one or more sensors, a wrist-worn condition of the wrapped geometric form factor. At 1211, the moving the content on the flexible display in response to the translating only when the wrist-worn condition is occurring.

At 1212, the gesture input of 1201 comprises a lifting operation elevating the electronic device from a first position to a second position in the three-dimensional space. At 1213, the gesture input of 1201 comprises a lifting operation moving the electronic device to a position in the three-dimensional space where a gravity direction passes through a loop defined by the wrapped geometric form factor.

At 1214, an electronic device comprises a deformable housing comprises a plurality of linkage members, a flexible display supported by the deformable housing, one or more sensors operable to determine a wrapped, wrist-worn geometric configuration of the electronic device, and one or more other sensors operable to detect when the electronic device changes orientation in three-dimensional space. At 1214, the electronic device comprises one or more processors operable with the one or more sensors and the one or more other sensors, the one or more processors operable to cause a content presentation on the flexible display to move along the flexible display as a function of the changes in the orientation of the electronic device in the three-dimensional space while the electronic device is in the wrapped, wrist-worn geometric configuration.

At 1215, the electronic device of 1214 further comprises an image capture device operable with the one or more processors. At 1215, the content presentation is generated by a preview mode of operation of the image capture device.

At 1216, the one or more processors of 1215 are further configured to cause the flexible display to present draw lines with the content presentation. At 1216, the draw lines indicate a field of view of the image capture device.

At 1217, the electronic device of 1214 comprises an image capture device operable to determine a direction of gaze from a wearer of the electronic device. At 1217, the one or more processors cause the content presentation to initially be presented within the direction of gaze from the wearer. At 1218, the changes in the orientation of the electronic device at 1214 comprise a rotation about a central axis of the wrapped, wrist-worn geometric configuration.

At 1219, a method in an electronic device comprises detecting, with at least a first sensor, a deformable device housing of the electronic device being transitioned to a wrapped geometry about a wrist. At 1219, the method comprises detecting, with at least a second sensor, a rotational and/or lifting operation of the electronic device in three-dimensional space.

At 1219, in response to the at least a first sensor detecting the wrapped geometry about the wrist and the at least a second sensor detecting the rotational and/or lifting operation, the method comprises causing, with one or more processors, content presented on a flexible display supported by the deformable device housing to move in proportion to the rotational and/or lifting operation. At 1220, an outward facing vector of 1219 extends distally from the content remains oriented in a constant direction during the rotational and/or lifting operation.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method in an electronic device, the method comprising:
detecting, with one or more sensors, a wrapped geometric form factor defined by a flexible display supported by a deformable housing and comprising a first portion and a second portion remote from the first portion such that the first portion faces in a first direction and the second portion faces in a second direction that is different from the first direction when the flexible display is in the wrapped geometric form factor;
presenting, with one or more processors, content on the flexible display in the first portion;
also detecting, with one or more other sensors, gesture input performing a lifting operation moving the electronic device from a first position in three-dimensional space to a second position in the three-dimensional space while the wrapped geometric form factor is occurring; and
moving, by the one or more processors, the content on the flexible display in response to the lifting operation from the first portion to the second portion.

2. The method of claim 1, wherein the first portion is a default location.

3. The method of claim 2, further comprising estimating a probable visible location for the content relative to a gaze of a wearer of the electronic device, wherein the second portion falls within the probable visible location.

4. The method of claim 1, further comprising detecting, using an image capture device, a gaze cone of a wearer of the electronic device, wherein the first portion is situated within the gaze cone.

5. The method of claim 1, wherein a direction of gravity intersects the first portion of the flexible display orthogonally when the electronic device is in the first position in the three-dimensional space.

6. The method of claim 5, wherein the direction of gravity passes through a loop defined by the wrapped geometric form factor when the electronic device is in the second position in the three-dimensional space.

7. The method of claim 5, wherein the direction of gravity fails to intersect the first portion of the flexible display after the lifting operation.

8. The method of claim 7, wherein the second portion situates atop a radius bone of the wrist of a wearer of the electronic device.

9. The method of claim 8, wherein the content comprises a preview view of an image capture device of the electronic device.

10. The method of claim 9, further comprising presenting draw lines with the content, the draw lines indicating a field of view of the image capture device.

11. The method of claim 1, further comprising identifying, with the one or more sensors, a wrist-worn condition of the wrapped geometric form factor, wherein the moving the content on the flexible display occurs only when the wrist-worn condition is occurring.

12. The method of claim 1, wherein the lifting operation transitions the electronic device to a camcorder support condition.

13. The method of claim 1, wherein a gravity direction passes through a loop defined by the wrapped geometric form factor after the lifting operation occurs.

14. An electronic device, comprising:
a deformable housing comprises a plurality of linkage members;
a flexible display supported by the deformable housing;
one or more sensors operable to determine a wrapped, wrist-worn geometric configuration of the electronic device;
one or more other sensors operable to detect when the electronic device changes orientation in three-dimensional space occurring from a rotation about a central axis of the wrapped, wrist-worn geometric configuration; and
one or more processors operable with the one or more sensors and the one or more other sensors, the one or more processors operable to cause a content presentation on the flexible display to move from a first location on the wrapped, wrist-worn geometric configuration to a second location on the wrapped, wrist-worn geometric configuration that is different from the first location as a function of the changes in the orientation of the electronic device in the three-dimensional space while the electronic device is in the wrapped, wrist-worn geometric configuration;
wherein the changes in the orientation of the electronic device comprise a rotation about a central axis of the wrapped, wrist-worn geometric configuration.

15. The electronic device of claim 14, further comprising an image capture device operable with the one or more processors, wherein the content presentation is generated by a preview mode of operation of the image capture device.

16. The electronic device of claim 15, the one or more processors further configured to cause the flexible display to present draw lines with the content presentation, the draw lines indicating a field of view of the image capture device.

17. The electronic device of claim 14, further comprising an image capture device operable to determine a direction of gaze from a wearer of the electronic device, wherein the one or more processors cause the content presentation to initially be presented within the direction of gaze from the wearer.

18. The electronic device of claim 14, wherein the central axis of the wrapped, wrist-worn geometric configuration extends along an arm of a wearer when the electronic device is in a wrist-worn condition.

19. A method in an electronic device, the method comprising:
detecting, with at least a first sensor, a deformable device housing of the electronic device being transitioned to a wrapped geometry about a wrist;
detecting, with at least a second sensor, a rotational and/or lifting operation of the electronic device in three-dimensional space; and
in response to the at least a first sensor detecting the wrapped geometry about the wrist and the at least a second sensor detecting the rotational and/or lifting operation, causing, with one or more processors, content presented on a flexible display supported by the deformable device housing to move from a first portion facing in a first direction to a second portion facing a second direction that is angularly displaced around the wrapped geometry.

20. The method of claim 19, wherein an outward facing vector extending distally from the content remains oriented in a constant direction during the rotational and/or lifting operation.
